(19) United States
(12) Patent Application Publication
(10) Pub. No.: US 2012/0191956 A1
(43) Pub. Date: Jul. 26, 2012

(54) PROCESSOR HAVING INCREASED PERFORMANCE AND ENERGY SAVING VIA OPERAND REMAPPING

(75) Inventor: Jay FLEISCHMAN, Ft. Collins, CO (US)

(73) Assignee: ADVANCED MICRO DEVICES, INC., Sunnyvale, CA (US)

(21) Appl. No.: 13/014,468

(22) Filed: Jan. 26, 2011

(51) Int. Cl. G06F 9/302

(52) U.S. Cl. 712/222; 712/E09.017

(57) ABSTRACT

Methods and apparatuses are provided for achieving increased processor performance and energy saving via reordering operand mapping as opposed to the actual operand data. The apparatus comprises a plurality of physical registers available for use storing operands and includes a unit capable of mapping logical registers to the plurality of physical registers. A multiplexer then reorders the operands by reordering the mapping of logical registers to the plurality of physical registers, which increases processor performance and energy saving by reordering narrow registers instead of wide registers. The method comprises mapping logical registers storing to physical registers storing operands in a processor and then reordering the mapping to achieve the equivalent of reordering the operands without reordering the operands from the physical registers in the processor.

### FIELD OF THE INVENTION

The present invention relates to the field of information or data processing. More specifically, this invention relates to the field of operand reordering techniques.

### BACKGROUND

Generally processors contain a number of computation execution units that execute decoded instructions and provide a result by performing computations on one or more operands. Some instructions are not commutative (i.e., subtraction), necessitating the operands to be in a particular order to produce the correct result. Other instructions may be commutative (e.g., addition and multiplication); however, the execution units require the operands to be a certain order. Reasons for operand order requirements include simplifying the microarchitecture of the execution unit, bringing a proven prior design into the next generation processor, or simply ease of manufacture. In any event, with multiple execution units having different operand order requirements, design choices must be made to minimize operand reordering while meeting the operand order requirements. Typically, these design choices are made by evaluating all of the operand order requirements and choosing the best default for operand order storage. In this way, the best default is intended to limit operand reordering, which involves reading one or more operands from physical registers and moving (multiplexing) those operands to change the order of the operands prior to execution of the instruction.

While the best default technique is intended to minimize operand reordering, it is nevertheless wasteful of power for cases where the operand data must still be multiplexed from the wide physical registers storing them. Typically, such physical registers can be 128 bits (or larger) in size and the power and time required to multiplex such wide operands can be substantial. Thus, operand reordering, while necessary, increases latency and power consumption in a processor or its operational units, and should be avoided whenever possible.

### BRIEF SUMMARY OF EMBODIMENTS OF THE INVENTION

An apparatus is provided for increased processor performance and energy saving via reordering operand mapping as opposed to the actual operand data. The apparatus comprises a plurality of physical registers available for use storing operands and includes a unit capable of mapping logical registers to the plurality of physical registers. A multiplexer then reorders the operands by reordering the mapping of logical registers to the plurality of physical registers, which increases processor performance and energy saving by reordering narrow registers instead of wide registers.

A method is provided for achieving increased processor performance and energy saving via reordering operand mapping as opposed to the actual operand data. The method comprises mapping logical registers storing to physical registers storing operands in a processor and then reordering the mapping to achieve the equivalent of reordering the operands without reordering the operands from the physical registers in the processor.

### BRIEF DESCRIPTION OF THE DRAWINGS

The present invention will hereinafter be described in conjunction with the following drawing figures, wherein like numerals denote like elements, and

FIG. 1 is a simplified exemplary block diagram of processor suitable for use with the embodiments of the present disclosure;

FIG. 2 is a simplified exemplary block diagram of computational unit suitable for use with the processor of FIG. 1;

FIG. 3 is a simplified exemplary block diagram illustrating operand mapping suitable for use with the computational unit of FIG. 2;

FIG. 4A is a simplified block diagram illustrating conventional operand reordering;

FIG. 4B is a simplified exemplary block diagram illustrating operand reordering according to an embodiment of the present disclosure; and

FIG. 5 is a flow diagram illustrating operand reordering according to an embodiment of the present disclosure.

### DETAILED DESCRIPTION OF THE INVENTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Moreover, as used herein, the word “processor” encompasses any type of information or data processor, including, without limitation, Internet access processors, Intranet access processors, personal data processors, military data processors, financial data processors, navigational processors, voice processors, music processors, video processors or any multimedia processors. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, the following detailed description or for any particular processor microarchitecture.

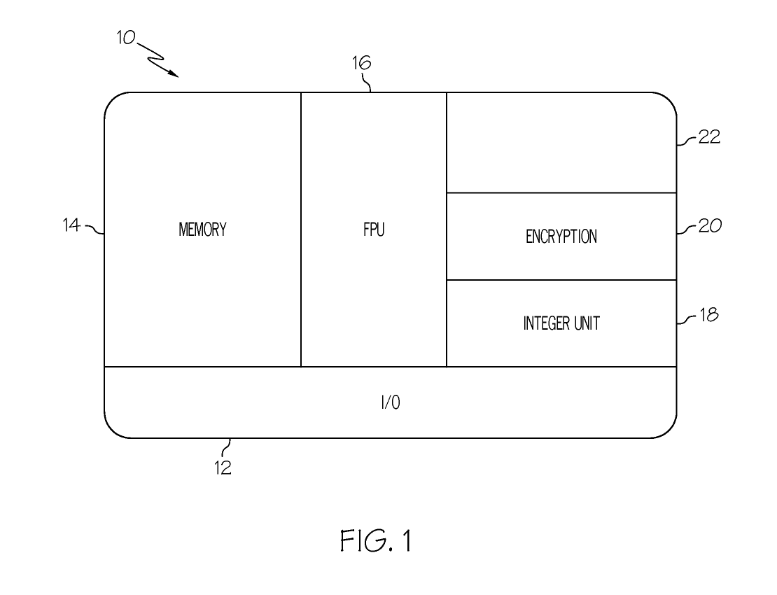

Referring now to FIG. 1, a simplified exemplary block diagram is shown illustrating a processor 10 suitable for use with the embodiments of the present disclosure. In some embodiments, the processor 10 would be realized as a single core in a large-scale integrated circuit (LSIC). In other embodiments, the processor 10 could be one of a dual or multiple core LSIC to provide additional functionality in a single LSIC package. As is typical, processor 10 includes an input/output (I/O) section 12 and a memory section 14. The memory 14 can be any type of suitable memory. This would include the various types of dynamic random access memory (DRAM) such as SDRAM, the various types of static RAM (SRAM), and the various types of non-volatile memory (PROM, EPROM, and flash). In certain embodiments, additional memory (not shown) “off chip” of the processor 10 can be accessed via the I/O section 12. The processor 10 may also include a floating-point unit (FPU) 16 that performs the float-point computations of the processor 10 and an integer processing unit 18 for performing integer computations. Additionally, an encryption unit 20 and various other types of units (generally 22) as desired for any particular processor microarchitecture may be included.

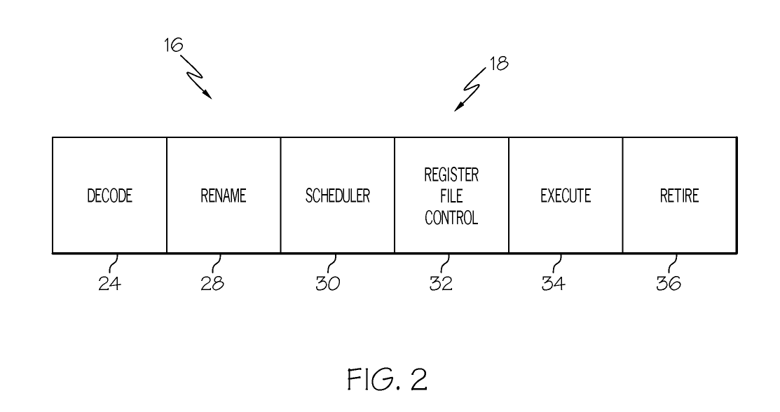

Referring now to FIG. 2, a simplified exemplary block diagram of a computational unit suitable for use with the processor 10 is shown. In one embodiment, FIG. 2 could operate as the floating-point unit 16, while in other embodiments FIG. 2 could illustrate the integer unit 18.

In operation, the decode unit 24 decodes the incoming operation-codes (opcodes) to be dispatched for the computations or processing. The decode unit 24 is responsible for the general decoding of instructions (e.g., x86 instructions and extensions thereof) and how the delivered opcodes may change from the instruction. The decode unit 24 will also pass on logical register numbers (LRNs) for any operands needed to perform the computation to the rename unit 28.

The rename unit 28 maps logical register numbers (LRNs) to the physical register numbers (PRNs) prior to scheduling and execution. In one embodiment, a register mapping table resides in the rename unit 28 and stores the correspondence between logical registers and the physical registers residing in the register file control unit (32 in FIG. 2).

The scheduler 30 contains a scheduler queue and associated issue logic. As its name implies, the scheduler 30 is responsible for determining which opcodes are passed to execution units and in what order. In one embodiment, the scheduler 28 accepts operand mapping from rename unit 26 and stores them in the scheduler 28 until they are eligible to be selected by the scheduler to issue to one of the execution pipes.

The register file control 32 holds the physical registers which are mapped to the logical registers by the rename unit 26. Source operands are read out of the physical registers by the execution units and results are written back into the physical registers. In one embodiment, the register file control 32 also check for parity errors on all operands before the opcodes are delivered to the execution units.

The execute unit(s) 34 may be embodied as any generation purpose or specialized execution architecture as desired for a particular processor. In one embodiment the execution unit may be realized as a single instruction multiple data (SIMD) arithmetic logic unit (ALU). In another embodiment, dual or multiple SIMD ALUs could be employed for super-scalar and/or multi-threaded embodiments, which operate to produce results and any exception bits generated during execution.

In one embodiment, after an opcode has been executed, the instruction can be retired so that the state of the floating-point unit 16 or integer unit 18 can be updated with a self-consistent, non-speculative architected state consistent with the serial execution of the program. The retire unit 36 maintains an in-order list of all opcodes in process in the floating-point unit 16 (or integer unit 18 as the case may be) that have passed the rename 26 stage and have not yet been committed by the architectural state. The retire unit 36 is responsible for committing all the floating-point unit 16 or integer unit 18 architectural states upon retirement of an opcode.

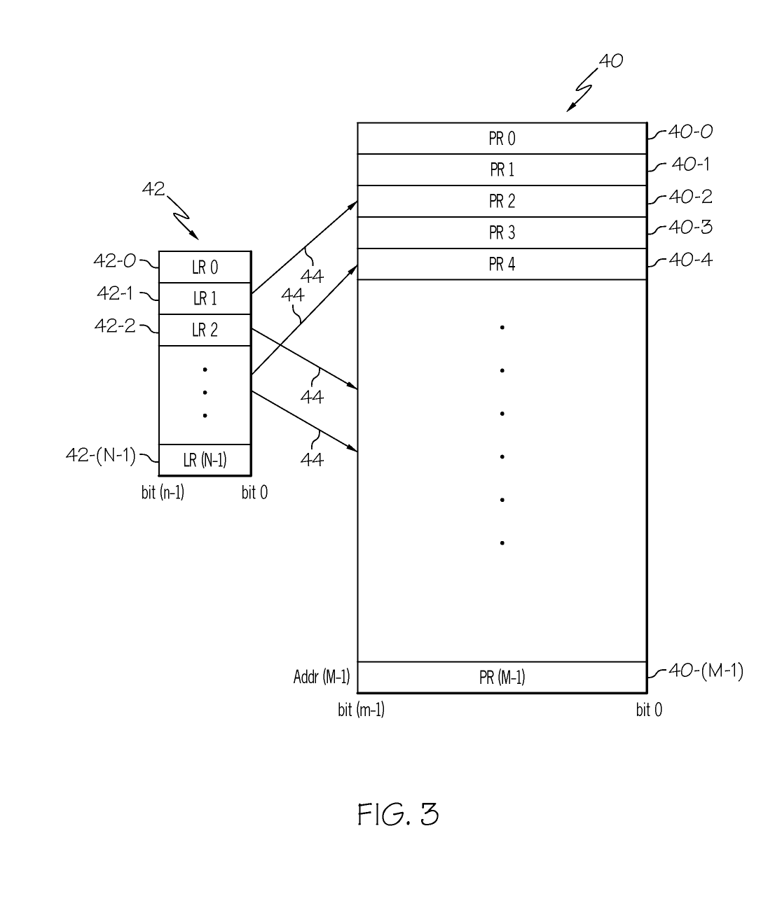

Referring now to FIG. 3, there is shown an illustration of renaming or mapping logical registers to physical registers suitable for use with a computational unit (be it floating-point or integer) of the present disclosure. In one embodiment, the physical registers 40 reside in the register file control unit (32 in FIG. 2) and are organized in one or more address blocks for reading and writing operations. The various physical registers, 40-0 through 40-(M−1), are limited in number and are committed to a particular use for so long as necessary for the performance of an instruction. The physical registers 40 are known as “wide” registers as they contain a large number of bits (bit 0 through bit (m−1)), which in various embodiments may be 64 bits, 128 bits, 256 bits, or more. At the conclusion (retirement) of the instruction, any available physical registers (such as those reclaimed from old, now obsolete mappings) are returned to a “free list” indicating that they are available for use by another instruction.

Also illustrated in FIG. 3 is a register mapping table 42, which contains the mapping of the physical registers 40 to logical registers. Logical registers are architected registers and may reside or be distributed through the processor 10 (or computational unit 16 or 18) as desired in any particular architecture. In one embodiment, the register mapping table 42 resides in the rename unit (28 in FIG. 2) so that the mappings of architected or logical registers to the physical registers 40 can be changed by renaming or changing the mapping as needed. In the register mapping table 42, the registers 42-0 through 42-(N−1) are known as “narrow” registers as they have few bits compared to the physical registers 40. Generally, the value N (the number of registers) of the register mapping table 42 corresponds to the number of logical registers and have a sufficient number of bits (n) to map (or point to) the complete address range of the physical registers 40. For example, if n=8, then the register mapping table 42 could point to 256 physical registers (in binary).

As illustrated in FIG. 3, the register mapping table 42 has mapped several logical registers to various physical registers as illustrated generally by arrows 44. For example, the logical register associated with LR1 (42-1) is mapped to physical register PR2 (40-2), and so on. In one embodiment this renaming (remapping) operation can be performed prior to the scheduler 30 (see FIG. 2) as the rename operation generally occurs prior to scheduling. This has the advantage of subsequently moving only the narrow mapping registers 42 through the computational unit instead of moving wide logical register values. Those skilled in the art will appreciate that it takes much less time and power to move 8 bit values than 128 bit values.

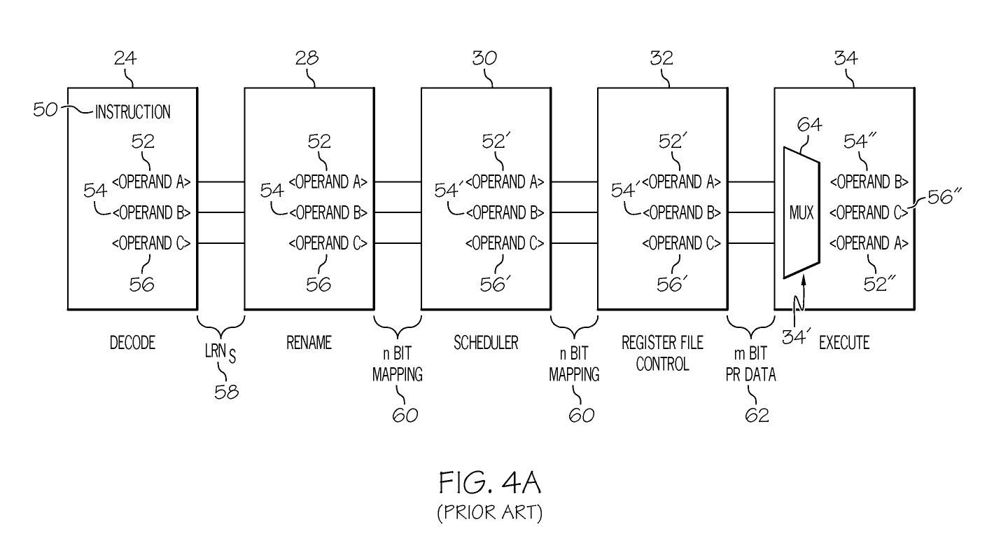

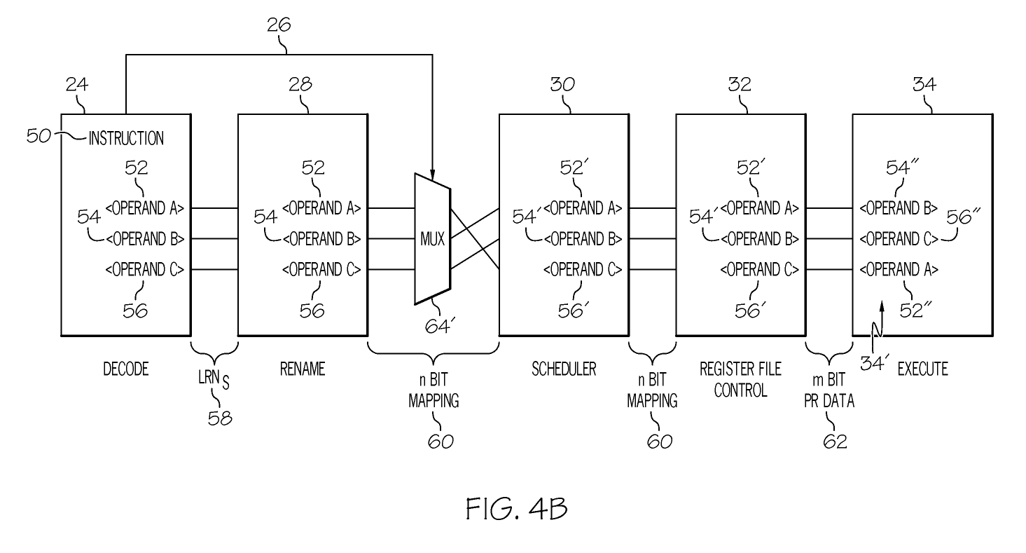

Referring now to FIG. 4A, there is shown a conventional operand reordering technique. Initially, instruction 50 is decoded by the decode unit 24. In this example, instruction 50 requires three operands (operand A (52), operand B (54) and operand C (56)) for completion. The logical register numbers (LRNs) are passed (58) from the decode unit to the rename unit 28 for mapping. As noted above, the logical registers are architected registers and may reside anywhere in the processor (or operational unit thereof) as desired for any microarchitecture. In one embodiment, the logical registers comprise or include the XMM or YMM registers of the x86 SSE and AVX instruction set. The rename unit maps the logical registers to physical registers as discussed above in conjunction with FIG. 2. The narrow (n bit, see FIG. 3) mapping registers (52′, 54′ and 56′) are passed (60) to the scheduler 30 and then to the register file control unit 32 where the wide (m bit) physical registers reside. At execution time, the m bit physical register (PR) data 62 is read by an execute unit 34, where it is determined that the operands (52″, 54″ and 56″) need to be reordered prior to processing. Conventionally, this reordering is done by a multiplexer (MUX) 64 under control (34′) of the execute unit. As can be seen in FIG. 4A, the operands emerge from the multiplexer 64 reordered as required for the computation called for in the instruction 50, and as needed by the microarchitecture of the particular execute unit. Thus, conventional reordering techniques multiplex the wide physical registers just prior to execution, which is both wasteful of power and delays completion of the instruction 50.

Referring now to FIG. 4B, there is shown an exemplary operand reordering technique according to the present disclosure. Operand reordering according to the embodiments of the present disclosure begins with decoding the instruction 50 (in decode unit 24 of FIG. 2) and determining that instruction 50 requires three operands (operand A (52), operand B (54) and operand C (56)) for completion. The logical register numbers (LRNs) are passed (58) from the decode unit to the rename unit 28 for mapping to physical registers as discussed above in conjunction with FIG. 2. As noted above, in one embodiment, the logical registers comprise or include the XMM or YMM registers of the x86 SSE and AVX instruction set. According to the embodiments of the present disclosure, the mapping registers are reordered at this stage providing the advantage of multiplexing narrow (e.g., 8 bit) registers instead of multiplex the wide (e.g., 128 or more bit) physical registers as discussed in conjunction with FIG. 4A. In one embodiment, a multiplexer 64′ under control (26) of the decode unit 24 is positioned between the rename unit 28 and the scheduler 30. This can be achieved by incorporating the multiplexer 64′ into the rename unit 28 or the scheduler unit 30 or the multiplexer can be an independent unit as illustrated in FIG. 4B. The now reordered narrow (n bit, see FIG. 3) mapping registers (52′, 54′ and 56′) are passed (60) to the scheduler 30 and then to the register file control unit 32 where the wide (m bit) physical registers reside. In other embodiments, the multiplexer 64′ could be positioned between the scheduler 30 and the register file control 32 (again, incorporation into those units is possible in some embodiments), however, the illustrated location of the multiplexer 63′ offers the advantage of having the operands reordered prior to scheduling which achieves greater time savings. At execution time, the m bit physical register (PR) data 62 is read by an execute unit 34, and can be processed immediately since the operands (52″, 54″ and 56″) have been reordered by reordering the mapping registers. For computations requiring a number of operand reordering, the power savings and performance improvement offered by the operand reordering technique of the present disclosure can be substantial.

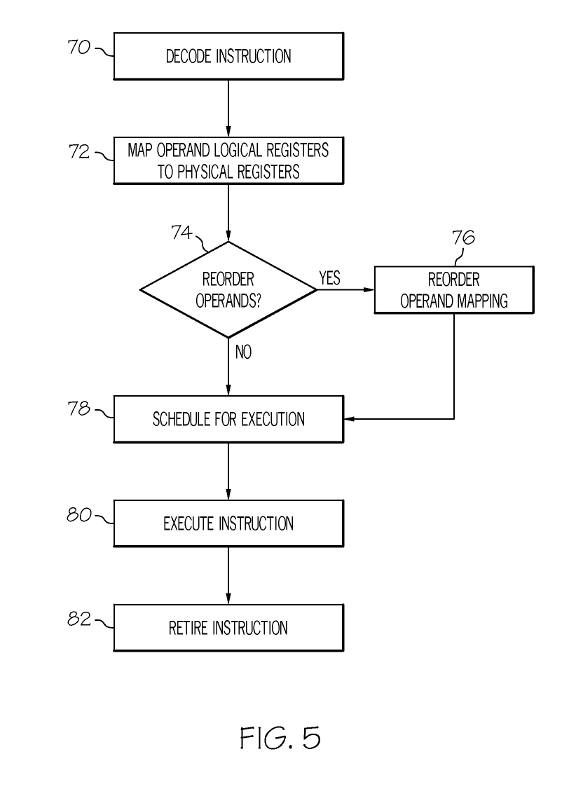

Referring now to FIG. 5, a flow diagram is shown illustrating the steps followed by various embodiments of the present disclosure for the processor 10, the floating-point unit 16, the integer unit 18 or any other unit 22 of the processor 10 that performs operand reordering according to the present disclosure. In step 70 an instruction is decoded (for example in decoder 24 of FIG. 2). Next, the logical registers storing the operands needed for processing the instruction are mapped (step 72) to physical registers (for example in rename unit 28). Decision 74 determines whether the decoded instruction necessitates operand reordering. If so, then step 76 reorders the mapping of the physical registers and logical registers as required to achieve the equivalent of physically reordering the (wide) operand values stored in the physical registers. If, however, the determination of decision 74 is that operands do not need to be reordered, or if step 76 has reordered the operands as required, step 78 schedules the instruction (in scheduler 30 of FIG. 2) for execution. Next, step 80 executes the instruction (in an execution unit 34 of FIG. 2). Finally, after execution, step 82 retires the instruction (for example in retire unit 36 of FIG. 2) and the processor, or a computational unit therein, can proceed to the next instruction. Thus, the operand reordering technique of the present disclosure saves both operational cycles and power consumption by not wasting time and energy multiplexing physical register data or reorder operands.

Various processor-based devices may advantageously use the processor (or computational unit) of the present disclosure, including laptop computers, digital books, printers, scanners, standard or high-definition televisions or monitors and standard or high-definition set-top boxes for satellite or cable programming reception. In each example, any other circuitry necessary for the implementation of the processor-based device would be added by the respective manufacturer. The above listing of processor-based devices is merely exemplary and not intended to be a limitation on the number or types of processor-based devices that may advantageously use the processor (or computational unit) of the present disclosure.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method, comprising:
mapping logical registers storing to physical registers storing operands in a processor; and
reordering the mapping to achieve the equivalent of reordering the operands without reordering the operands from the physical registers in the processor.

2. The method of claim 1, which includes the step of processing an instruction via the processor after reordering the mapping.

3. The method of claim 2, wherein the step of processing an instruction via the processor after reordering the mapping further comprises:
scheduling the instruction for execution in an execution unit; and
executing the instruction in the execution unit.

4. The method of claim 3, which includes the step of retiring the instruction after executing the instruction in the execution unit.

5. The method of claim 3, wherein the executing step further comprises executing floating-point instructions within a floating-point unit of the processor.

6. The method of claim 3, wherein the executing step further comprises executing integer instructions within an integer unit of the processor.

7. A method, comprising:
storing, within a processor, a first operand in a first physical register and a second operand in a second physical register, the first physical register being mapped to a first logical register and the second physical register being mapped to a second logical register; and
in response to determining an instruction necessitates reordering of the first and second operations, performing the reordering by reordering the mapping of the first logical register to the second physical register and reordering the mapping of the second logical register to the first physical register.

8. The method of claim 7, which includes the step of processing the instruction after reordering the mapping of the first and second logical registers.

9. The method of claim 8, wherein the processing step further comprises processing floating-point instructions within a floating-point unit of the processor after reordering the mapping of the first and second logical registers.

10. The method of claim 8, wherein the processing step further comprises processing integer instructions within an integer unit of the processor after reordering the mapping of the first and second logical registers.

11. The method of claim 8, wherein the step of processing the instruction after reordering the mapping of the first and second logical registers further comprises:
scheduling the instruction for execution in an execution unit; and
executing the instruction in the execution unit.

12. The method of claim 11, which includes the step of retiring the instruction after executing the instruction in the execution unit.

13. A processor comprising:
a plurality of physical registers available for use storing operands;
a unit capable of mapping logical registers to the plurality of physical registers; and
a multiplexer capable of reordering the operands by reordering the mapping of logical registers to the plurality of physical registers.

14. The processor of claim 13, further comprising scheduling and execution units for performing computations using the first and second operands after reordering the mapping of the first and second logical registers.

15. The processor of claim 14, which includes an integer computational unit for performing integer computations after reordering the mapping of the first and second logical registers.

16. The processor of claim 14, which includes a floating-point computational unit for performing floating-point computations after reordering the mapping of the first and second logical registers.

17. The processor of claim 13, which includes other circuitry to implement one of the group of processor-based devices consisting of: a computer; a digital book; a printer; a scanner; a television or a set-top box.
